(19) United States
(12) Patent Application Publication
(10) Pub. No.: US 2004/0193520 A1
(43) Pub. Date: Sep. 30, 2004

(54) Automated understanding and decomposition of table-structured electronic documents

(76) Inventors: Christina LaComb, Cropseyville, NY (US); Eric Klein, Schenectady, NY (US); Marc Laymon, Clifton Park, NY (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/400,982

(22) Filed: Mar. 27, 2003

(51) Int. Cl. G06F 17/60

(52) U.S. Cl. 705/35

(57) ABSTRACT

Systems and methods for automatically understanding and decomposing unstructured tabular information are described. No constraints are placed on the origin or format of these documents when originally submitted; the documents may be in an unstructured and/or nonstandard format, and they may be electronic or flat files. The systems and methods of this invention generally comprise obtaining an electronic ASCII-formatted document, analyzing and understanding the contents of the document, and decomposing the information contained in the document, utilizing a variety of algorithms and heuristics to do this. Embodiments of this invention automatically process a multitude of financial documents, thereby eliminating the need for human interaction with such documents in many cases and lowering the costs associated with processing such documents.

### CROSS REFERENCE TO RELATED APPLICATIONS

This invention is related to commonly-owned, co-pending U.S. patent application Ser. No. ______, entitled “Automated Understanding, Extraction and Structured Reformatting of Information in Electronic Files,” filed herewith on Mar. 27, 2003, which is hereby incorporated in full by reference. This invention is also related to commonly-owned, co-pending U.S. patent application Ser. No. ______, entitled “Mathematical Decomposition of Table-Structured Electronic Documents,” filed herewith on Mar. 27, 2003, which is also hereby incorporated in full by reference.

### FIELD OF THE INVENTION

The present invention relates generally to systems and methods for automatically processing electronic documents. More specifically, the present invention relates to systems and methods that automatically understand and decompose unstructured tabular information from ASCII-formatted documents.

### BACKGROUND OF THE INVENTION

Financial statements such as balance sheets, income statements, cash flow statements, and the like, are commonly generated for businesses. Such statements may be formatted as tables of information, for example, in ASCII text, EBCDIC text, Excel spreadsheets, PDF files, Postscript files, HTML documents, or the like. When reviewing such information, humans use inherent layout features, such as alignment and positioning, as clues for interpreting the logical meaning of the information contained therein. While such information is capable of being read and understood by a person, it may not be so easily read and understood by a computer. Therefore, and since human intervention is subject to error, it would be desirable to have a way to identify and break down the information contained in documents, such as financial statements, so that computers could be used to “understand” and decompose such documents. Such documents could then be reconstructed into an intermediate XML or HTML format. Thereafter, the intermediate XML or HTML versions of the documents could be converted into various formats capable of being integrated with other systems, such as data warehouses, underwriting and origination systems. Having an intermediate XML or HTML format would significantly ease integration efforts by providing a single format from which all other formats could be derived. This would make exchanging information between parties and/or businesses much easier than currently possible.

While there are currently systems and methods that allow some such documents to be understood, these systems and methods all impose certain constraints on the documents that are being submitted. For example, they may require that the documents be presented in a standardized format, or they may require that the system have pre-defined information about the format that is expected in the submitted document. For example, commonly-owned U.S. patent application Ser. No. 09/391,573, entitled “Methods and Apparatus for Print Scraping” describes systems and methods for automatically understanding and extracting information from such documents, but these systems and methods require the document type to be pre-classified as to what type of document it is, and they rely on the use of pre-created scripts that operate on a per-customer and/or per-document type basis to map the information contained therein. Additionally, commonly-owned U.S. patent application Ser. No. 09/391,773, entitled “Method and Apparatus for Network-Enabled Virtual Printing” describes systems and methods for capturing information from a document, compiling the captured information into a temporary file, and then communicating the captured information in the temporary file to a remote system where the information can be processed. However, this invention also relies on the use of pre-created scripts that operate on a per-customer and/or per-document type basis to map the information contained therein. It would be desirable to have systems and methods that did not impose such constraints on documents. For example, it would be desirable to have systems and methods that would allow documents to be submitted in any format (i.e., that would allow formats typically generated by commercially-available tools, as well as formats indicative of the financial industry, to be submitted). It would be further desirable to have systems and methods that did not require the use of pre-created scripts to map the information contained therein, instead allowing the information to be automatically understood by the dynamic system.

Additionally, systems and methods for decomposing table-structured documents exist, but they generally decompose documents that have been presented as images, such as those output from a bitmapped scanning of a document. It would be desirable to have systems and methods that allow for the decomposition of tables that are submitted as, or that can be easily converted to, ASCII-formatted text.

There are presently no suitable systems and methods available for allowing computers to understand documents that are submitted in any format, not just those submitted in a standardized format. Thus, there is a need for such systems and methods. There is also a need for such systems and methods to automatically identify and break down information contained in such documents into its constituent parts. There is yet a further need for such systems and methods to be capable of effectively decomposing tables that are presented as ASCII-formatted text. There is particularly a need for such systems and methods to be capable of understanding and decomposing electronic table-structured ASCII-formatted financial documents. Many other needs will also be met by this invention, as will become more apparent throughout the remainder of the disclosure that follows.

### SUMMARY OF THE INVENTION

Accordingly, the above-identified shortcomings of existing systems and methods are overcome by embodiments of the present invention, which relates to systems and methods that allow computers to automatically understand documents that are submitted in any format, not just those that are submitted in a standardized format. In some embodiments, these systems and methods automatically identify and break down information contained in such documents into its constituent parts. Embodiments of the systems and methods of this invention may be capable of effectively decomposing tables that are presented as ASCII-formatted text. Furthermore, embodiments of the systems and methods of this invention may be capable of understanding and decomposing electronic table-structured ASCII-formatted financial documents.

One embodiment of this invention comprises a method for understanding and decomposing a document. This method may comprise utilizing at least one of the following algorithms to understand and decompose the document: one or more pre-processing algorithms; one or more token identification algorithms; one or more token type identification algorithms; one or more column count identification algorithms; one or more column boundary identification algorithms; one or more column type identification algorithms; one or more token-to-column assignment algorithms; and one or more line merging algorithms, wherein no prior identification of a document type is required, no prior identification of an expected format for the document type is required, and no pre-created scripts are required to map contents of the document.

Another embodiment of this invention comprises system for understanding and decomposing a document. This system may comprise a means for utilizing at least one of the following algorithms to understand and decompose the document: one or more pre-processing algorithms; one or more token identification algorithms; one or more token type identification algorithms; one or more column count identification algorithms; one or more column boundary identification algorithms; one or more column type identification algorithms; one or more token-to-column assignment algorithms; and one or more line merging algorithms, wherein no prior identification of a document type is required, no prior identification of an expected format for the document type is required, and no pre-created scripts are required to map contents of the document.

Yet another embodiment of this invention comprises a method for understanding and decomposing a document. This method may comprise: preprocessing text in the document; identifying a physical layout of the document by establishing tokens; characterizing the tokens in the document as at least one of: numeric, text and date; establishing a column count of the number of columns in the document; establishing column boundaries for each column; establishing a column type for each column; assigning tokens to a column; identifying spanning tokens; identifying wrapping lines; identifying a table construct and a relationship between the tokens and table cells; identifying special rows and special cells in the document; identifying logical layout of the document; interpreting text in the document; and applying validation rules to verify totals and subtotals are correct.

Further features, aspects and advantages of the present invention will be more readily apparent to those skilled in the art during the course of the following description, wherein references are made to the accompanying figures which illustrate some preferred forms of the present invention, and wherein like characters of reference designate like parts throughout the drawings.

### DESCRIPTION OF THE DRAWINGS

The systems and methods of the present invention are described herein below with reference to various figures, in which:

FIG. 1 is a flowchart showing the overall strategy followed by embodiments of this invention; and

FIG. 2 is a flowchart showing the basic steps followed by one embodiment of this invention.

### DETAILED DESCRIPTION OF THE INVENTION

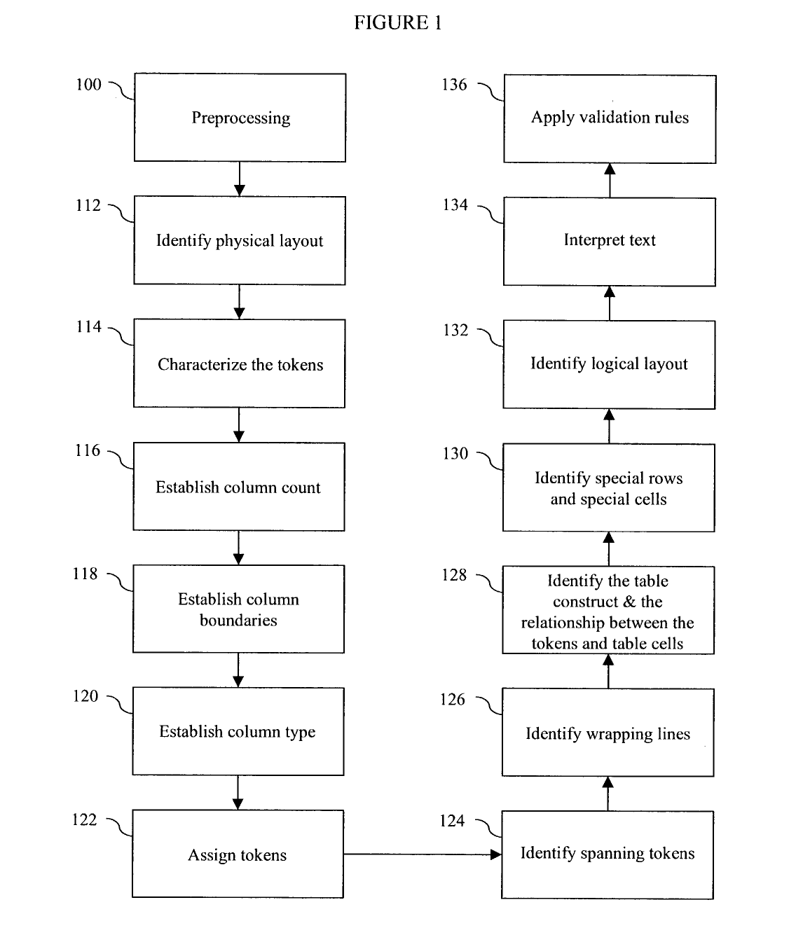

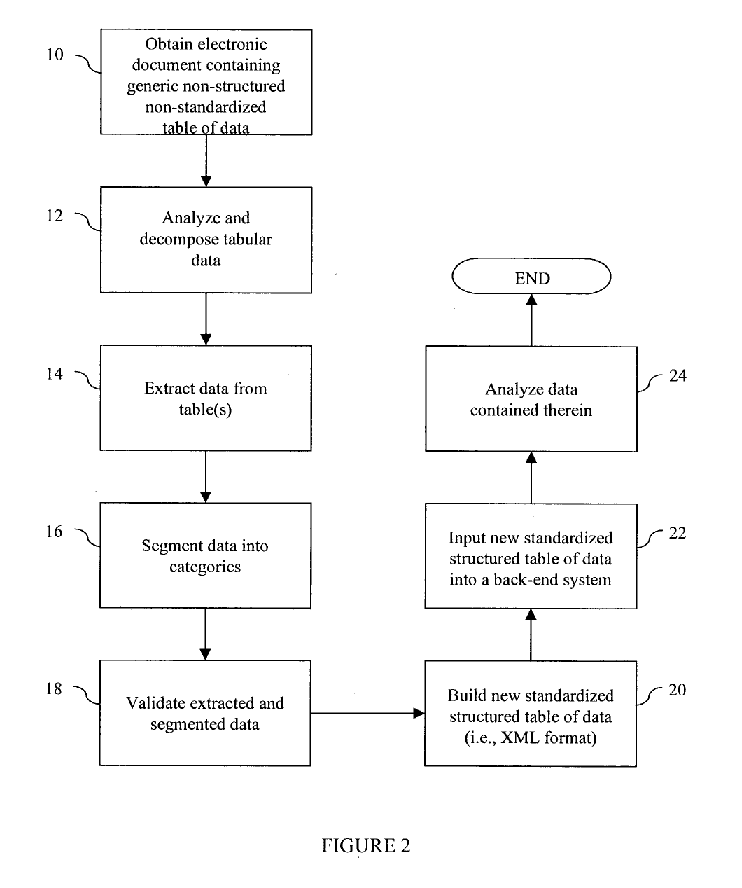

For the purposes of promoting an understanding of the invention, reference will now be made to some preferred embodiments of the present invention as illustrated in FIGS. 1-2, and specific language used to describe the same. The terminology used herein is for the purpose of description, not limitation. Specific structural and functional details disclosed herein are not to be interpreted as limiting, but merely as a basis for the claims as a representative basis for teaching one skilled in the art to variously employ the present invention. Well-known server architectures, web-based interfaces, programming methodologies and structures are utilized in this invention but are not described in detail herein so as not to obscure this invention. Any modifications or variations in the depicted systems and methods, and such further applications of the principles of the invention as illustrated herein, as would normally occur to one skilled in the art, are considered to be within the spirit of this invention.

The present invention comprises systems and methods that utilize a family of algorithms, preferably operationalized within a single engine or computer system, that can effectively automate the decomposition of information from tabular documents, such as a balance sheet. These systems and methods basically take unstructured tabular documents and, by being able to understand them, they can decompose the information contained therein. Although many embodiments described herein relate to electronic ASCII-formatted financial documents, many other types and formats of documents could be utilized in this invention. For example, the tabular documents could be formatted as Microsoft Office documents and/or spreadsheets, PDF files, Postscript files, HTML documents, or the like. Furthermore, this invention could be utilized for any type of document, not just financial documents. Preferably, however, the documents are table-structured documents.

Embodiments of this invention are targeted to businesses that offer commercial loans. Typically, as part of the loan approval process, customers are required to submit financial statements, either once or periodically, for risk assessment and origination purposes. This invention provides systems and methods for quickly and accurately integrating these financial statements using automated data extraction. Automating the operations behind the “understanding” of these documents allows more accurate tracking and validity testing of the submitted data to be provided, thereby providing optimum consistency, accuracy, and timeliness in the decomposition, validation, and integration of such ASCII documents into automated systems, as well as providing more accurate tracking and validity testing of the submitted data. Automating the task of understanding such documents also decreases the cost associated therewith, allowing for more frequent monitoring of high-risk customers, and thereby reducing lenders' overall risk.

Embodiments of the present invention may be used to have a computer “understand” any type of document and decompose such documents. In some embodiments, the documents received are electronic financial statements in ASCII format. However, documents may also be received in a variety of other formats, such as for example, via fax and/or flat files that may then be scanned and saved as electronic files. Additionally, electronic documents in the form of EBCDIC text, Microsoft Office documents and/or spreadsheets, PDF files, Postscript files, HTML documents, or the like may be submitted. This invention allows all such documents to be received and “understood;” no standardized format is required for the initial submission of the documents.

This invention comprises a set of tools that aid in the process of electronic data extraction, preferably from electronic table-structured financial statements. A set of deterministic rules is established and applied to decompose a financial document so that document analysis and recognition can be automated. These rules consider both the contents and the layout of the document to make sense of the information contained therein, utilizing visual clues that are presented throughout the document in the form of semantic and syntactic conditions.

The basic steps that are performed by systems and methods in one embodiment of this invention are shown in FIG. 2. First, the system obtains an electronic document 10. This document may contain generic, non-structured and/or non-standardized tables of data. If the document, as submitted, is not in electronic ASCII format, it may first need to be scanned and saved as some sort of electronic format, and be converted to ASCII text. Thereafter, the tabular data may be analyzed and decomposed 12 by the system. In some embodiments, the data may be extracted from the document 14, and the system may then segment the extracted data into various categories 16, and validate the extracted data 18. Thereafter, a new, structured, standardized document may be created 20. Once an intermediate standardized, structured document exists, such a document may be utilized in various financial systems 22, where the data contained therein can be analyzed 24.

In a preferred embodiment of this invention, the documents received comprise ASCII-renditions of financial documents that are received as electronic files via the Internet. The automated document analysis and recognition steps preferably comprise: analyzing the layout of the document, and determining the words and context of the information contained therein.

There are many ways in which a financial document can be rendered an ASCII file, which can then be transmitted to a system of the present invention via the Internet. Many commercially available financial tools can output their contents directly as ASCII documents. If a financial software package does not support output in the form of a standard character set such as ASCII or EBCDIC, generally users can either “Save As Text” or print to a generic ASCII printer through Microsoft Windows. Once an ASCII rendering is obtained, users can easily attach the ASCII file to an electronic mail message and send it to a predetermined e-mail address. Alternatively, the ASCII file may be transmitted to a predetermined host via FTP or HTTP. The systems and methods of this invention are designed to support and monitor the transmission of all such file types.

“Print to HTTP” technology has also been created, which comprises a Microsoft Windows print driver that effectively converts any windows output to an ASCII file, and then automates HTTP upload of the file to a pre-designated URL. Using such technology eases the operations that are required to generate the electronic versions of the financial statements submitted.

Upon receipt of the ASCII document, embodiments of the systems and methods of this invention comprise the overall strategy shown in FIG. 1. First, the systems and methods of this invention may perform preprocessing of the text 100, such as handling the special characters (i.e., tabs and dot-leaders) and processing the non-ASCII characters.

The system may then identify the physical layout of the document 112, by establishing tokens (i.e., a sequence of characters) that should be treated as a group, which can comprise measuring and utilizing information about each character's proximity to neighboring characters.

Thereafter, each token may be characterized 114 as being either a numeric, text or date token, based on the occurrence of alphabetic characters, wherein if the characters conform to a known “number” representation, they may be classified as a numeric token, if they conform to a known “date” pattern, they may be classified as a date token, and otherwise they may be classified as a text token.

The system may then establish the column count 116 by utilizing statistical analysis of the distribution of tokens per row, by utilizing measures of central tendency to identify the number of columns represented in the table. The tokens contained within rows where the number of tokens is exactly equal to the assigned column count may be considered definitively assigned to the particular column in which they appear.

Next, the system may establish the column boundaries 118 by using positional information from those tokens that are definitively assigned to a given column. Thus, the right-most and/or left-most positions of the tokens assigned to each given column may be used as indicators of each column's right and left boundaries. These boundaries may then be systematically extended in order to fill in the gaps between columns.

The system may then establish the column type 120 of each column by analyzing the frequency of occurrence of each token type within a given column, or by assuming a pre-defined column type pattern, such as for example, a text column followed by one or more numeric columns.

Thereafter, the system may assign to a column 122 any tokens that could not be definitively assigned to a column previously.

Next, the system may identify any “spanning tokens” 124. As used herein, “spanning tokens” comprise any tokens that span two or more columns based on the range of the columns into which the token is positionally based, as well as the occurrence of other tokens within the same columns.

The system may then identify “wrapping lines” 126. As used herein, “wrapping lines” comprise rows in which the row text is comprised of two or more lines, by identifying words or symbols commonly used to separate text within a sentence (i.e., “for”, “to”, “and”, “by”, “; ”, “,”, “&”, etc.), and merging those cells so that the cell contains the complete text.

The system may then identify the table construct and the relationships between the tokens and table cells 128 by using row and column information.

Finally, the system may then identify “special rows” and “special cells” 130 such as blank lines (i.e., rows with no tokens) or separator lines and/or cells (i.e., rows or cells where all tokens are of a separator data type such as “−” and “=”). Additionally, the system may identify “header rows” as rows where only the text column has a token, and the remaining columns are blank. The system may identify “title rows” as spanning rows above the first row where the number of cells is equal to the column count. The system may identify “total rows” as the last row in the table where the token count is equal to the column count, or where the token count is equal to one less than the column count.

Thereafter, the systems may identify the logical layout of the document 132 in terms of labeled tokens (i.e., document title, qualifier, table entity, table value, table column heading, totals, subtotals, etc.). Knowledge about the layout structure can aid in identifying the tokens. For example, generally the column header is above the table, and the description is likely the widest column in the table. Labels may be associated with tokens based on words within the tokens or the position of the tokens. The ratio of digits to alphabetic characters can indicate if the token is a textual or numeric value column. Mathematics, context, and locations of the tokens may be utilized to identify totals/subtotals of the table. In embodiments, a probabilistic strategy may be employed, comprising: establishing the logical objects that are likely to be included in the document; assigning properties, hypotheses, probabilities and rules to each token in the document; measuring each token against an object and establishing the probability of a hit or match therewith; establishing multiplicity of each object (i.e., how many of each object are likely to be contained in the document); using multiplicity of each object; and/or using multiplicity and probability to label each token.

The systems may then interpret the text 134 by assigning text to objects that have been identified for a given document type. This results in a solution space of candidate object mappings and probabilities. An XML standard for a given document type may be used as the superset of possible objects that may be contained in that type of document. For example, a balance sheet may include a list of assets, liabilities and shareholder's equities, all of which may comprise various subcategories listed thereunder. An XML standard document may be created that lists all the possible categories/objects that may appear in a balance sheet, and other standard documents may be created for the various other financial statements or other documents that may be decomposed by the systems and methods of this invention. A lexicon of accounting terms, or other relevant terms, may be used to test variations of the various categories/objects within a document, as can pattern matching and semantic techniques.

Finally, in some embodiments of this invention, the systems may apply validation rules 136, which are applied to each solution based on probabilities. Mathematical rules may be employed to verify that the totals and/or subtotals are correct, and accounting principles may be employed to verify that the decomposition was proper (i.e., assets=liabilities). In addition to these internal consistency checks, external checks may also be made. For example, the decomposed data may be compared to commercial data warehouse value ranges or the like. Probabilistic operations may result in several suitable solutions. The solution with the highest probability is tested first, then, progression is made down the solution space until the single best solution is found.

The systems and methods of this invention execute a series of algorithms designed to understand and decompose the document's contents based on semantic and syntactic clues located throughout the document. These algorithms automate the “understanding” of the financial documents, removing the requirement for human intervention in cases where the information contained in such documents can be effectively “understood” by a computer. These algorithms are preferably operationalized as six separate steps: (1) Pre-Processing; (2) Token Identification; (3) Token Type Identification; (4) Column Count Identification; (5) Column Boundary Identification; (6) Column Type Identification; (7) Token-to-Column Assignment; and (8) Line Merging.

The pre-processing step may involve removing anomalous characters from a file and replacing some of these characters with other characters that will not change the meaning of the document. This step may involve removing all dollar signs because they often appear far from the corresponding number, thereby hindering proper parsing. This step may also involve replacing tab characters with 5 spaces so that spacing is maintained uniformly so that spaces can be treated consistently. This step may also involve removing sequences of multiple underscores and periods since they offer no information, and such characters are not needed to analyze the document structure. This step may also involve removing all characters with non-ASCII values since such characters have an undefined meaning. Finally, this step may involve replacing runs of one or two dashes with a zero because such characters normally signify the absence of a certain value for a period.

The tokenizing algorithm preferably identifies, as tokens, all strings of non-space characters having no more than two consecutive internal space characters. The token identification algorithm may comprise identifying textual elements (i.e., tokens) for each row of text that are n or more spaces from a left or right non-space neighbor, where n=2 for the first sampling in some embodiments and n=4 for the first sampling in other embodiments. Embodiments may skip all single tokens that have only a “$” character. This algorithm may be extended to establish a suitable “white space threshold” via statistical evaluation distribution of “white space markers” throughout the entire document.

The token type identification algorithm may comprise identifying the token's type (i.e., numeric, string or date) by analyzing the combination of numbers and symbols contained within the token. If numbers are surrounded by “( )”, then the sign of the number may be changed to negative, and the “(“and ”)” may be stripped from the number. The token may be deemed numeric if the token conforms to Java Double data type after stripping the “$”, “( )” and “,” characters out. The token may be deemed text if it contains one or more alphabetic characters. The token may be deemed a date, or part of a date, if it conforms to one of the predefined date formats.

The column count identification algorithm may comprise determining a statistical average of the population of tokens in each row. Various methods may be employed to do this. For example, column count identification may be performed by determining the maximum number of tokens in a row, the mean number of tokens in each row, the median number of tokens in each row, or more preferably, by determining the mode of the number of tokens in a row and using that mode as the number of columns in the document.

The column boundary identification algorithm preferably only uses rows that contain the exact number of tokens equal to the number of columns in the document. The column boundary identification algorithm may comprise sequentially positioning the tokens within the columns identified by the column count identification algorithm, and then establishing the start and end points of those columns. One method that may be employed to do this comprises: assuming each token belongs to the column corresponding to its position (i.e., token 1 belongs to column 1, token 2 belongs to column 2, etc.); retaining the minimum start position as the start column boundary and the maximum end position as the end column boundary; and then extending the boundaries proportionately to the size of the columns to accommodate gaps between columns.

The column type identification algorithm may comprise assigning the default column types that are generally found in table oriented financial statements to the columns in the document. Simply stated, the first column in the document is assumed to consist of a label representing the significance of the subsequent data in the row. Subsequent columns are considered data columns. A data column generally has a date near the top describing what period of time the data in the column describes and a list of numbers representing certain measurements, usually in currency, of financial activity during the time period.

For those rows in which the number of tokens does not exactly match the number of columns, a token-to-column assignment may be done. The token-to-column assignment algorithm may comprise assigning each token to one or more columns based on the boundaries of the column(s) within which it falls, adjusting as needed to accommodate tokens that span multiple cells. If any part of the token exists within a column boundary, the token may be considered to span that column. In embodiments, for tokens that span multiple columns, starting with the right-most token, it can be determined if the right-most column that the right-most token spans is occupied by anything else in that row or anything spanning from other rows. If the column is occupied by something else in another row, that token will preferably not be allowed to span that right-most column. However, if the column is not occupied by anything else in any other rows, that token may be allowed to span that right-most column and will be considered a multiple cell spanning token. Similar determinations may be made for the remaining tokens that span multiple columns. The algorithm may also assign tokens to columns in a way that gives preference to assigning number-type and date-type tokens to non-spanning cells in the data columns.

The line merging algorithm may comprise natural language processing. This algorithm may look for known separator words, such as prepositions and conjunctions, since they are known to have words surrounding them on both sides in English phrases. If a known separator word is found as either the last word or first word in a given token, the token may be combined with the cell above or the cell below, respectively. Other clues besides separator words may be used to find incomplete phrases that should be joined with a surrounding cell. These clues may include leading words that begin with a lowercase letter, cells that begin with a digit, and cells that begin with certain punctuation such as an ampersand or a semi-colon. Lastly, this algorithm may assure closure of parenthesis in tokens. For example, when a left parenthesis is found, cells below may be joined until the corresponding right parenthesis is found.

Once the information contained in the document is analyzed and decomposed, it may then be extracted and validated, and the information may be easily regenerated as an XML representation of the target document type (i.e., balance sheet, income statement, cash flow statement, etc.). A number of existing XML standards are available for representing the contents of financial documents, with the Extensible Business Reporting Language (XBRL) standard appearing to be the most widely favored within the industry. However, any suitable XML standard that effectively characterizes the target document type may be used.

Once an intermediate XML version of the information exists, the XML documents may be submitted to one or more target financial systems. By utilizing a commercial-off-the-shelf ETL (Extract, Transform and Load) tool such as Data Junction or Informatica, no custom coding should be needed to convert the XML information into the target data source. However, should the target data source not be supported by existing ETL tools, a custom solution could be easily built. Using the intermediate XML formatted documents greatly eases integration-efforts by providing a single standardized format from which all other formats can be derived. Furthermore, the XML documents are portable, self-describing, well-structured, internally consistent, vendor neutral, and are the de facto industry standard for data exchange between diverse systems. As such, they are easily integrated with a myriad of existing financial and data warehousing systems.

As described above, embodiments of the systems and methods of this invention allow electronic financial documents to be automatically understood and decomposed. Advantageously, these systems and methods place no constraints on the origin or format of the originally submitted documents, instead allowing any type of tabular document to be submitted for automatic processing. Embodiments of this invention are targeted towards all types of financial table-structured ASCII documents, regardless of their origin, and no special constraints are placed on the format or origin of the documents that are submitted. The algorithms this invention utilizes are generally applicable to all financial table-structured documents.

Various embodiments of the invention have been described in fulfillment of the various needs that the invention meets. It should be recognized that these embodiments are merely illustrative of the principles of various embodiments of the present invention. Numerous modifications and adaptations thereof will be apparent to those skilled in the art without departing from the spirit and scope of the present invention. For example, while this invention has been described in terms of systems and methods that automatically understand and decompose electronic ASCII-formatted financial documents, numerous other types of tabular documents could be understood and decomposed by the systems and methods of this invention. Thus, it is intended that the present invention cover all suitable modifications and variations as come within the scope of the appended claims and their equivalents.

What is claimed is:

1. A method for understanding and decomposing a document, the method comprising:
utilizing at least one of the following algorithms to understand and decompose the document: one or more pre-processing algorithms; one or more token identification algorithms; one or more token type identification algorithms; one or more column count identification algorithms; one or more column boundary identification algorithms; one or more column type identification algorithms; one or more token-to-column assignment algorithms; and one or more line merging algorithms,
wherein no prior identification of a document type is required, no prior identification of an expected format for the document type is required, and no pre-created scripts are required to map contents of the document.

2. The method of claim 1, wherein the method is performed automatically by a computer system.

3. The method of claim 1, wherein the document comprises tabular information.

4. The method of claim 1, wherein the document comprises at least one of: an ASCII text document, an EBCDIC text document, a spreadsheet, a PDF file, a Postscript file, and an HTML document.

5. The method of claim 1, wherein the document comprises a financial statement.

6. The method of claim 5, wherein the financial statement comprises at least one of: a balance sheet, an income statement, and a cash flow statement.

7. The method of claim 1, wherein the document comprises an electronic document.

8. The method of claim 7, wherein the electronic document is obtained electronically via at least one of: the Internet, an electronic mail message, an intranet, an extranet, and a scanner.

9. The method of claim 1, wherein the one or more pre-processing algorithms comprise at least one of:
removing anomalous characters from the file and replacing at least some of the anomalous characters with other characters that will not change the meaning of the document; removing dollar signs; replacing tab characters with a predetermined number of spaces; removing sequences of multiple underscores; removing sequences of multiple periods; removing characters having non-ASCII values; and replacing runs of one or two dashes with a zero.

10. The method of claim 1, wherein the one or more token identification algorithms comprise at least one of:
identifying, as tokens, strings of non-space characters having no more than two consecutive internal space characters; identifying textual elements for each row of text that are a predetermined number of spaces from a left or right non-space neighbor; skipping single tokens that comprise only a “$” character; and establishing a predetermined white space threshold via statistical evaluation distribution of white space markers throughout the document.

11. The method of claim 1, wherein the one or more token type identification algorithms comprise:
identifying the token type as at least one of: numeric, text, and date.

12. The method of claim 1, wherein the one or more column count identification algorithms comprise:
determining a statistical average of the population of tokens in each row.

13. The method of claim 1, wherein the one or more column boundary identification algorithms comprise at least one of:
sequentially positioning the tokens within the columns identified by the one or more column count identification algorithms; establishing a start point of each column; establishing an end point of each column; and extending the start point and the end point of each column proportionately to the size of the columns to accommodate gaps between columns.

14. The method of claim 1, wherein the one or more column type identification algorithms comprise:
assigning default column types to columns in the document.

15. The method of claim 1, wherein the one or more token-to-column assignment algorithms comprise:
assigning each token to one or more columns based on the boundaries of the columns within which the token falls and adjusting the token assignments as necessary to accommodate tokens that span multiple cells.

16. The method of claim 1, wherein the one or more line merging algorithms comprise:
utilizing natural language processing to combine multiple tokens in consecutive rows that should actually be a single token.

17. A system for understanding and decomposing a document, the system comprising:
a means for utilizing at least one of the following algorithms to understand and decompose the document: one or more pre-processing algorithms; one or more token identification algorithms; one or more token type identification algorithms; one or more column count identification algorithms; one or more column boundary identification algorithms; one or more column type identification algorithms; one or more token-to-column assignment algorithms; and one or more line merging algorithms,
wherein no prior identification of a document type is required, no prior identification of an expected format for the document type is required, and no pre-created scripts are required to map contents of the document.

18. The system of claim 17, wherein a computer system is used to automatically understand and decompose the document.

19. The system of claim 17, wherein the document comprises tabular information.

20. The system of claim 17, wherein the document comprises at least one of: an ASCII text document, an EBCDIC text document, a spreadsheet, a PDF file, a Postscript file, and an HTML document.

21. The system of claim 17, wherein the document comprises a financial statement.

22. The system of claim 21, wherein the financial statement comprises at least one of: a balance sheet, an income statement, and a cash flow statement.

23. The system of claim 17, wherein the document comprises an electronic document.

24. The system of claim 23, wherein the electronic document is obtained electronically via at least one of: the Internet, an electronic mail message, an intranet, an extranet, and a scanner.

25. The system of claim 17, wherein the one or more pre-processing algorithms comprise at least one of:
removing anomalous characters from the file and replacing at least some of the anomalous characters with other characters that will not change the meaning of the document; removing dollar signs; replacing tab characters with a predetermined number of spaces; removing sequences of multiple underscores; removing sequences of multiple periods; removing characters having non-ASCII values; and replacing runs of one or two dashes with a zero.

26. The system of claim 17, wherein the one or more token identification algorithms comprise at least one of:
identifying, as tokens, strings of non-space characters having no more than two consecutive internal space characters; identifying textual elements for each row of text that are a predetermined number of spaces from a left or right non-space neighbor; skipping single tokens that comprise only a “$” character; and establishing a predetermined white space threshold via statistical evaluation distribution of white space markers throughout the document.

27. The system of claim 17, wherein the one or more token type identification algorithms comprise:
identifying the token type as at least one of: numeric, text, and date.

28. The system of claim 17, wherein the one or more column count identification algorithms comprise:
determining a statistical average of the population of tokens in each row.

29. The system of claim 17, wherein the one or more column boundary identification algorithms comprise at least one of:
sequentially positioning the tokens within the columns identified by the one or more column count identification algorithms; establishing a start point of each column; establishing an end point of each column; and extending the start point and the end point of each column proportionately to the size of the columns to accommodate gaps between columns.

30. The system of claim 17, wherein the one or more column type identification algorithms comprise:
assigning default column types to columns in the document.

31. The system of claim 17, wherein the one or more token-to-column assignment algorithms comprise:
assigning each token to one or more columns based on the boundaries of the columns within which the token falls and adjusting the token assignments as necessary to accommodate tokens that span multiple cells.

32. The system of claim 17, wherein the one or more line merging algorithms comprise:
utilizing natural language processing to combine multiple tokens in consecutive rows that should actually be a single token.

33. A method for understanding and decomposing a document, the method comprising:
preprocessing text in the document;
identifying a physical layout of the document by establishing tokens;
characterizing the tokens in the document as at least one of: numeric, text and date;
establishing a column count of the number of columns in the document;
establishing column boundaries for each column;
establishing a column type for each column;
assigning tokens to a column;
identifying spanning tokens;
identifying wrapping lines;
identifying a table construct and a relationship between the tokens and table cells;
identifying special rows and special cells in the document;
identifying logical layout of the document;
interpreting text in the document; and
applying validation rules to verify totals and subtotals are correct.
